(19) United States
(12) Patent Application Publication
(10) Pub. No.: US 2024/0096223 A1
(43) Pub. Date: Mar. 21, 2024

(54) METHOD AND APPARATUS FOR REPORTING FLIGHT PATH OF TERMINAL IN MOBILE COMMUNICATION SYSTEM

(71) Applicant: Samsung Electronics Co., Ltd., Gyeonggi-do (KR)

(72) Inventors: Taeseop LEE, Gyeonggi-do (KR); Anil AGIWAL, Gyeonggi-do (KR); Sangyeob JUNG, Gyeonggi-do (KR)

(21) Appl. No.: 18/468,187

(22) Filed: Sep. 15, 2023

(30) Foreign Application Priority Data
Sep. 16, 2022 (KR) 10-2022-0116800
Dec. 23, 2022 (KR) 10-2022-0182813

(51) Int. Cl. G08G 5/00; H04W 36/32

(52) U.S. Cl. CPC G08G 5/0013; G08G 5/0039; H04W 36/32

(57) ABSTRACT

The disclosure relates to a 5G or 6G communication system for supporting a higher data transmission rate. A UE in a 5G or 6G communication system for supporting a higher data transmission rate that may efficiently report a flight path of the UE is disclosed. The UE may include a transceiver; and at least one processor configured to receive, from a base station via the transceiver, a first message for configuring a flight path update notification, identify that a flight path is updated, and transmit, to the base station via the transceiver, a second message including a flight path update indication for indicating that the flight path is updated based on the first message and the identification.

### CROSS-REFERENCE TO RELATED APPLICATION(S)

This application is based on and claims priority under 35 U.S.C. § 119 to Korean Patent Application Nos. 10-2022-0116800 and 10-2022-0182813, filed on Sep. 16, 2022 and Dec. 23, 2022, respectively, in the Korean Intellectual Property Office, the disclosure of each of which is incorporated herein by reference in its entirety.

### BACKGROUND

### 1. Field

The disclosure relates to operations of a terminal and a base station in a mobile communication system. Specifically, the disclosure relates to a method and an apparatus for efficiently reporting a flight path of a terminal by the terminal.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Meanwhile, there is a need of a method for efficiently reporting a flight path of a terminal.

### SUMMARY

A method for efficiently reporting a flight path of a terminal by the terminal in a mobile communication system is needed.

According to an embodiment, a terminal in a wireless communication system is provided, the terminal including a transceiver and at least one processor configured to receive, from a base station via the transceiver, a first message for configuring a flight path update notification, identify that a flight path is updated, and transmit, to the base station via the transceiver, a second message including a flight path update indication for indicating that the flight path is updated based on the first message and the identification.

According to an embodiment, a base station in a wireless communication system is provided, the base station including a transceiver and at least one processor configured to transmit, to a terminal via the transceiver, a first message for configuring a flight path update notification, and receive, from the terminal via the transceiver, a second message including a flight path update indication for indicating that a flight path is updated in case that the flight path being updated is identified.

According to an embodiment, a method performed by a terminal in a wireless communication system is provided, the method including receiving, from a base station, a first message for configuring a flight path update notification, identifying that a flight path is updated and transmitting, to the base station, a second message including a flight path update indication for indicating that the flight path is updated based on the first message and the identification.

According to an embodiment, a method performed by a base station in a wireless communication system is provided, the method including transmitting, to a terminal, a first message for configuring a flight path update notification and receiving, from the terminal, a second message including a flight path update indication for indicating that a flight path is updated in case that the flight path being updated is identified.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a next-generation mobile communication system according to an embodiment;

FIG. 2 illustrates a function of reporting a moving path of an aerial UE in a next-generation mobile communication system according to an embodiment;

FIG. 3 illustrates a function of updating a flight path of an aerial UE in a next-generation mobile communication system according to an embodiment;

FIG. 4 is a flow diagram illustrating a process in which an aerial UE reports whether to update a flight path to a gNB and the gNB makes a request for an updated path in the next-generation mobile communication system according to an embodiment;

FIG. 5 is a flow diagram illustrating a process of reporting an updated flight path of an aerial UE to a gNB in a next-generation mobile communication system according to an embodiment;

FIG. 6 is a flow diagram illustrating a process of periodically reporting an updated flight path of an aerial UE to a gNB in a next-generation mobile communication system according to an embodiment;

FIG. 7 is a block diagram illustrating a structure of a UE according to an embodiment; and

FIG. 8 is a block diagram illustrating a structure of a gNB according to an embodiment.

### DETAILED DESCRIPTION

Hereinafter, the operation principle of the disclosure will be described in detail with reference to the accompanying drawings. In the following description of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout this Specification.

In the following description, terms for identifying access nodes, terms referring to network entities, terms referring to messages, terms referring to interfaces between network entities, terms referring to various identification information, and the like, are illustratively used for the sake of descriptive convenience. Therefore, the disclosure is not limited by the terms as used below, and other terms referring to subjects having equivalent technical meanings may be used.

In the following description, a base station (BS) is an entity that allocates resources to terminals, and may be at least one of a gNode B, an eNode B, a Node B, a wireless access unit, a base station controller, and a node on a network. A terminal may include a UE, a mobile station (MS), a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station. Further, in the following description, long term evolution (LTE) or LTE-advanced (LTE-A) systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, “5G” may be the concept that covers the exiting LTE, LTE-A, or other similar services. In addition, based on determinations by those skilled in the art, the embodiments of the disclosure may also be applied to other communication systems through some modifications without significantly departing from the scope of the disclosure. Herein, it will be understood that each block of flowchart illustrations, and combinations of blocks in the flowchart illustrations, can be implemented by computer program instructions.

These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used in embodiments of the disclosure, the term “unit” refers to a software element or a hardware element, such as a field programmable gate array (FPGA) or an application specific integrated circuit (ASIC), which performs a predetermined function. However, the term “unit” does not always have a meaning limited to software or hardware. The “unit” may be constructed either to be stored in an addressable storage medium or to execute one or more processors. Therefore, the term “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Furthermore, the “unit” in the embodiments may include one or more processors.

In the following description, the disclosure will be described using terms and names defined in the 5GS and NR standards, which are the latest standards specified by the 3rd generation partnership project long term evolution (3GPP LTE) among the existing communication standards, for the convenience of description. However, the disclosure is not limited by these terms and names, and may be applied in the same way to systems that conform other standards. For example, the disclosure may be applied to the 3GPP 5GS/NR (5th generation mobile communication standards).

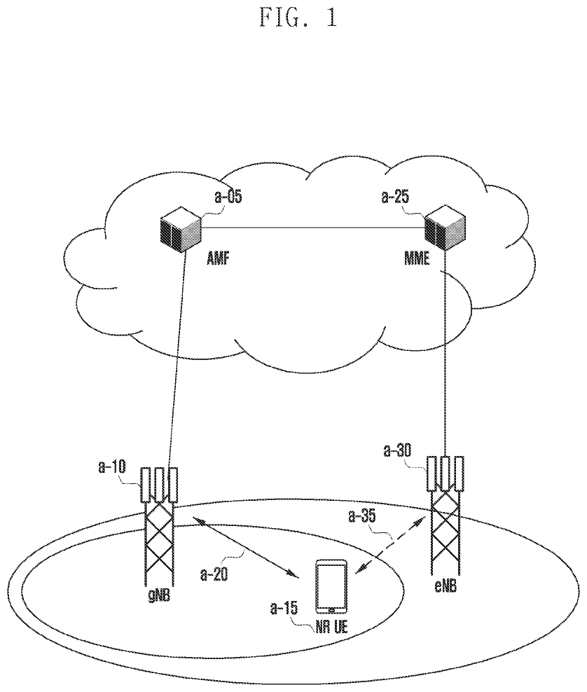

FIG. 1 illustrates a structure of a next-generation mobile communication system.

Referring to FIG. 1, a radio access network of a next-generation mobile communication system (new radio (NR)) includes a next-generation base station (new radio node B (gNB)) a-10 and an access and mobility management function (AMF) a-05 (new radio core network). A user terminal (new radio user equipment, hereinafter, referred to an NR UE or a terminal) a-15 accesses an external network through the gNB a-10 and the AMF a-05.

In FIG. 1, the gNB corresponds to an evolved Node B (eNB) of the general LTE system. The gNB may be connected to the NR UE through a radio channel and may provide better service than the conventional node B as indicated by reference numeral a-20. Since all user traffic is served through a shared channel in the next-generation mobile communication system, a device for collecting and scheduling status information of buffer statuses, available transmission power statuses, and channel statuses of UEs is required, which corresponds to the gNB a-10. One gNB generally controls a plurality of cells. The gNB may have a bandwidth wider than the conventional maximum bandwidth in order to implement super-high-speed data transmission compared to general LTE and may apply orthogonal frequency division multiplexing (OFDM) through radio access technology and further apply beamforming technology. Further, an adaptive modulation and coding (AMC) scheme of determining a modulation scheme and a channel coding rate is applied depending on the channel status of the UE. The AMF a-05 performs a function of supporting mobility, configuring a bearer, configuring quality of service (QoS), and the like. The AMF a-05 is a device performing a various control functions as well as a mobility management function for the UE and is connected to a plurality of base stations. Further, the next-generation mobile communication system may be linked to the conventional LTE system, and the AMF a-05 is connected to a mobility management entity (MME) a-25 through a network interface. The MME a-25 is connected to an eNB a-30 corresponding to an LTE base station. The UE supporting LTE-NR dual connectivity may transmit and receive data while maintaining the connection not only to the gNB but also to the eNB as indicated by reference numeral a-35.

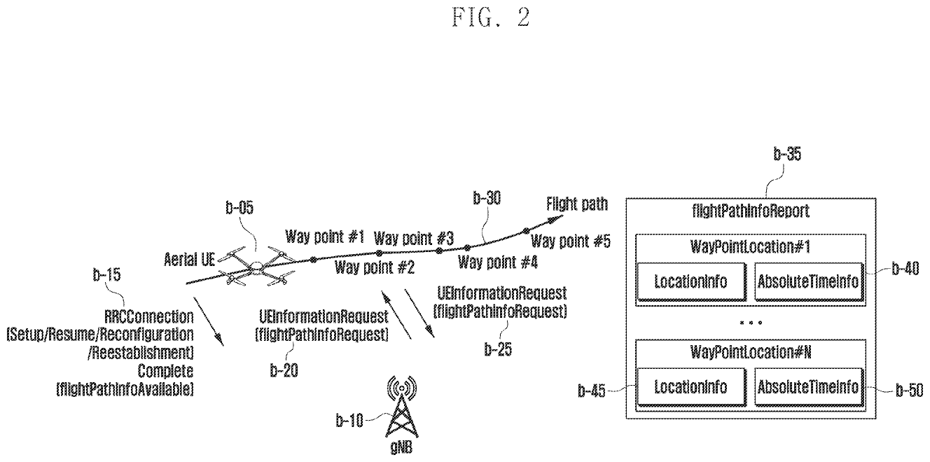

FIG. 2 illustrates a function of reporting a flight path of an aerial UE in a next-generation mobile communication system according to an embodiment.

The next-generation mobile communication system may be used as communication means for public mobility means such as an uncrewed/unmanned aerial vehicle (UAV) or uncrewed/unmanned aerial mobility (UAM). To this end, a function for supporting a communication service of the aerial UE will be introduced in the next-generation mobile communication system, based on the aerial UE.

The UAV/UAM has the use case in which movement is performed along a predetermined path flight b-30. Accordingly, when the gNB b-10 knows the predetermined path, the information (for example, the predetermined path) may be used for supporting mobility (for example, handover) of the aerial UE b-05. To this end, the aerial UE b-05 may inform the gNB b-10 that the aerial UE itself has the flight path information through predetermined RRC messages, for example, RRCConnectionSetupComplete, RRCConnectionResumeComplete, RRCConnectionReestablishmentComplete, RRCConnectionReconfigurationComplete, and the like, as indicated by reference numeral b-15. The gNB b-10 may make a request for the flight path information to the aerial UE b-05 through a UEInformationRequest message b-20. The aerial UE b-05 receiving the request from the gNB b-10 may report the flight path information (IE FlightPathInfoReport) to the gNB b-10 through a UEInformationResponse message b-25. The flight path information b-35 may be configured in the form of a list of way point (location of spot) information b-40 through which the aerial UE b-05 should pass. At this time, the way point information b-40 may include location information b-45 of each way point and expected time information b-50 when the aerial UE passes through the corresponding point.

When making a request for the flight path information to the aerial UE b-05 through the UEInformationRequest message b-20, the gNB b-10 may indicate the maximum number of way points (or the number of waypoints to be reported) which can be reported through the UEInformationResponse message b-25 and whether to insert the time information b-50 into the way point information b-40.

The aerial UE b-05 may report flight path information to the gNB b-10 through the UEInformationResponse message b-25. The aerial UE b-05 may report the maximum number of waypoints configured by the gNB b-10 through the UEInformationRequest message b-20 or information on N waypoints within a range of the maximum number of waypoints defined in the standard to the gNB b-10 (or when the gNB configures the number of waypoints to be reported, the aerial UE may report information on the waypoints corresponding to the number to the gNB). Further, only when the gNB b-10 indicates to insert time information into the waypoint information b-40 through the UEInformationRequest message b-20, the aerial UE b-05 may insert the time information b-50 and, otherwise, may insert the time information without any gNB configuration.

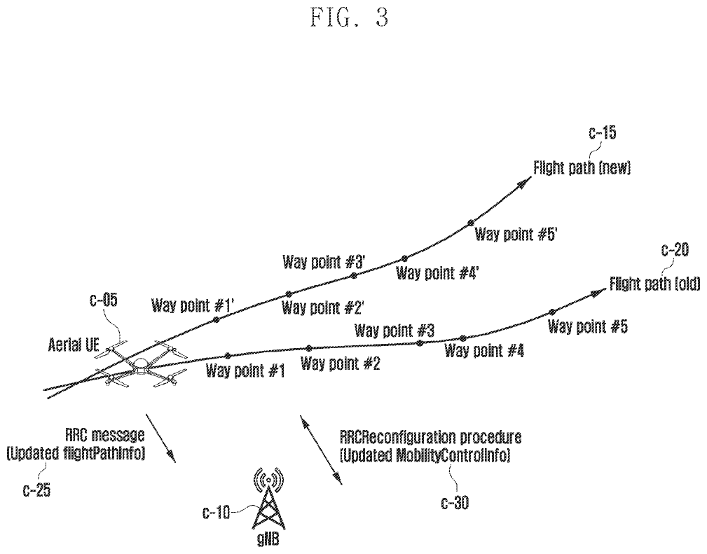

FIG. 3 illustrates a function of updating a flight path of the aerial UE in the next-generation mobile communication system according to an embodiment.

After an aerial UE c-05 reports a flight path c-20 to a gNB c-10 through the process of FIG. 2, the flight path of the aerial UE c-05 may be changed to a new path c-15. The change in the flight path may be intentionally performed by a UAV/UAM user and a server or performed by an external environment (weather, traffic congestion, or the like). When the flight path is changed, the aerial UE c-05 may report Updated flightPathInfo (changed flight path information) to the gNB c-10 through a predetermined RRC message c-25. At this time, the Updated flightPathInfo may include all pieces of waypoint information for the new flight path c-15 or partially include only changed waypoint information compared to the conventionally reported flight path c-20.

When receiving the report on the changed flight path information c-25 from the aerial UE c-05, the gNB c-10 may optimize supporting mobility of the aerial UE c-05, based on the changed flight path information. For example, the gNB c-10 may detect in advance cell information (frequency, bandwidth, or the like) operated by at least one gNB located in the waypoint to which the aerial UE c-05 will move along the changed flight path and reconfigure measurement and (conditional) handover of the aerial UE c-05 through an RRCReconfiguration procedure c-30 based on the cell information or perform in advance a signaling operation between gNBs required for the handover (HO) of the aerial UE c-05, so as to optimize supporting mobility.

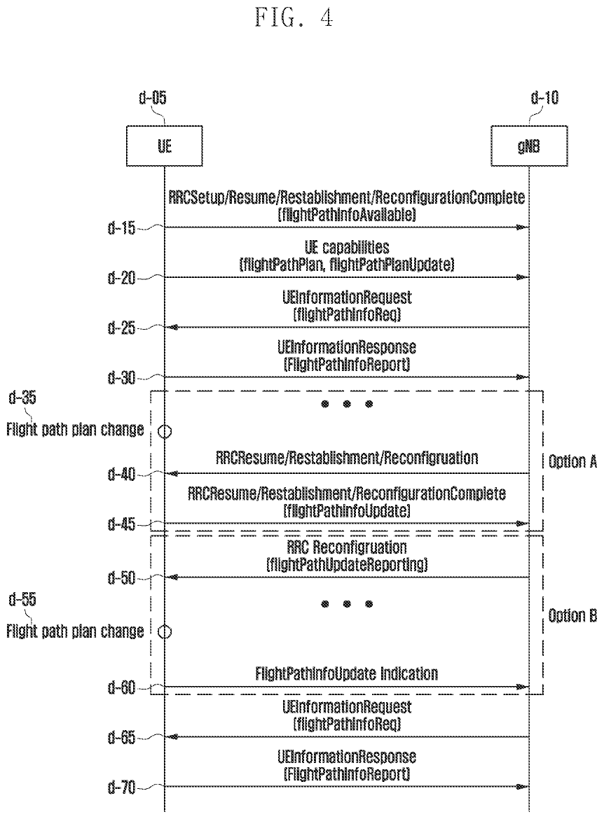

FIG. 4 is a flow diagram illustrating a process in which the aerial UE reports whether to update a flight path to the gNB and the gNB makes a request for an updated path in the next-generation mobile communication system according to an embodiment.

When the conventionally reported flight path is changed, a UE d-05 may report whether to update a flight path to a gNB d-10. Thereafter, the gNB may indicate the UE to report the updated flight path.

In operation d-15, the UE d-05 may report that the UE itself has flight path information to the gNB d-10 through an RRCSetupComplete/RRCResumeComplete/RRCReestablishmentComplete/RRCReconfiguratio nComplete message. In order to report the existence of the flight path information, the messages may contain an indicator of 1 bit such as flightPathInfoAvailable.

In operation d-20, the UE d-05 may report its own capability information to the gNB d-10. At this time, through the capability information, it may be indicated whether the UE supports the flight path information report and whether the UE supports flight path information update.

In operation d-25, the gNB d-10 may make a request for reporting the flight path to the UE d-05 through a UEInformationRequest message. At this time, the maximum number of waypoints (or the number of waypoints to be reported) which can be reported by the UE d-05 through a UEInformationResponse message d-30 and whether to insert time information into waypoint information may also be indicated.

In operation d-30, the UE d-05 may report flight path information to the gNB d-10 through a UEInformationResponse message. The aerial UE d-05 may report the maximum number of waypoints configured by the gNB d-10 through the UEInformationRequest message d-25 or information on N waypoints within a range of the maximum number of waypoints defined in the standard to the gNB d-10 (or when the gNB configures the number of waypoints to be reported, the aerial UE may report information on the waypoints corresponding to the number to the gNB). Further, only when the gNB d-10 indicates to insert time information into the waypoint information through the UEInformationRequest message d-25, the UE d-05 may insert the time information and, otherwise, may insert the time information without any gNB configuration.

The following options are considered through a method by which the aerial UE d-05 reports whether to update a flight path to the gNB d-10. According to an embodiment, the aerial UE d-05 may report whether to update the flight path to the gNB d-10 through at least one method of a first option or a second option below.

1. First Option A:

In operation d-35, the flight path of the aerial UE d-05 is changed, and the UE d-05 may detect the change in the flight path. Thereafter, when RRC resume/reestablishment/Reconfiguration procedures are performed, the gNB d-10 may transmit RRCResume/RRCReestablishment/RRCReconfiguration messages to the UE d-05 in operation d-40. In operation d-45, when a flight path update condition is met while the aerial UE d-05 transmits RRCResumeComplete/RRCReestablishmentComplete/RRCReconfigurationComplete messages to the gNB d-10, an indicator (for example, flightPathInfoUpdate) indicating whether to update the flight path may be included. For example, the indicator may be 1 bit.

2. Second Option B:

In operation d-50, when the flight path of the aerial UE d-05 is changed, the gNB d-10 may configure the UE d-05 to report whether to update the flight path through an RRC Reconfiguration procedure. At this time, in order to prevent gNB load from increasing due to the too frequent flight path update reports of the UE, the gNB d-10 may also configure a prohibit timer value indicating a minimum time interval between the path update reports (for example, when the prohibit timer is configured, the UE may start the prohibit timer when reporting the flight path update and cannot report a new path update before the corresponding prohibit timer expires).

In operation d-55, the flight path of the aerial UE d-05 is changed, and the UE d-05 may detect the change in the flight path. When the change in the flight path of the UE d-05 is detected or the UE d-05 has a new flight path in operation d-55, the UE d-05 may start a procedure for reporting whether to update the flight path to the gNB d-10.

When a flight path update condition is met, the aerial UE d-05 may report whether to update the flight path to the gNB d-10 in operation d-60. In order to report whether to update the flight path to the gNB d-10, the UE d-05 may insert an indicator (for example, flightPathInfoUpdate) indicating whether to update the flight path into a predetermined RRC message (for example, UEAssistanceInformation) and transmit the RRC message or may transmit a medium access control control element (MAC CE) for reporting the flight path update to the gNB d-10. For example, the indicator may be 1 bit.

When the first Option A is used among the options, the aerial UE d-05 may reduce signaling load by reporting whether to update the flight path through RRCResumeComplete/RRCReestablishmentComplete/RRCReconfigurationComplete messages instead of transmitting a separate RRC message or a MAC CE to report whether to update the flight path. However, in this case, the UE d-05 is able to report the flight path update only when receiving an RRCResume/RRCReestablishment/RRCReconfiguration message from the gNB d-10, and thus a delay time from a time point d-35 at which the flight path is actually changed to a time point d-45 at which the flight path update is reported may be generated.

When the second Option B is used among the options, the aerial UE d-05 may transmit a separate RRC message or a MAC CE to the gNB d-10 to report whether to update the flight path. In this case, the UE d-05 may report whether to update the flight path to the gNB d-10 right after detecting the change in the flight path.

The gNB d-10 detecting the update of the flight path of the aerial UE d-05 through the process (first Option A or second Option B) may make a request for reporting the changed flight path to the UE d-05 in operation d-65. At this time, the gNB d-10 may configure the UE d-05 whether to newly report all pieces of waypoint information for the changed flight path regardless of the conventionally reported flight path d-30 or partially report only the changed waypoint information based on the conventionally reported flight path d-30.

In operation d-70, the aerial UE d-05 may report changed flight path information according to a request from the gNB in operation d-65. At this time, the UE d-05 may newly report all pieces of waypoint information for the changed flight path or may partially report only the changed waypoint information compared to the conventionally reported flight path d-30. For example, when the conventionally reported flight path includes five waypoints (w1, w2, w3, w4, and w5), the flight path is changed and thus two waypoints (w4 and w5) of the five waypoints may be changed to waypoints (w4′ and w5′) and a new waypoint (w6) may be added. In this case, the UE d-05 may report information on all waypoints (w1, w2, w3, w4′, w5′, and w6) included in the changed path or may partially report only the changed waypoints (w4′, w5′, and w6). Further, even when only some of the location and time information for specific way points are changed, all pieces of the location and time information for the corresponding waypoints may be newly reported or only the changed location or time information may be partially reported.

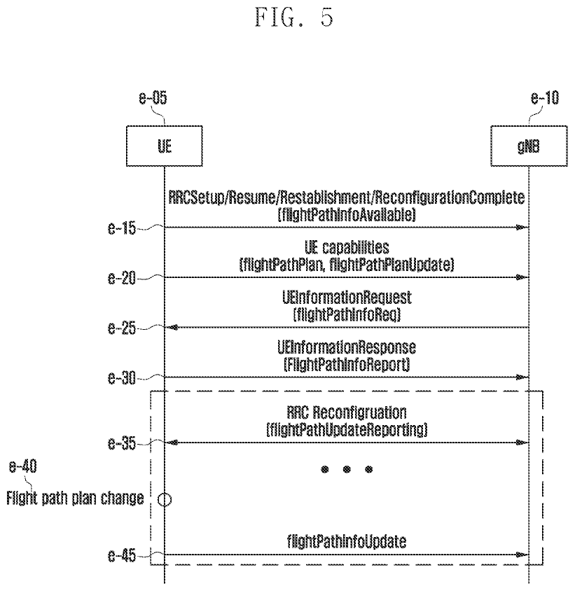

FIG. 5 is a flow diagram illustrating a process of reporting an updated flight path of the aerial UE to the gNB in the next-generation mobile communication system according to an embodiment.

In operation e-15, an aerial UE e-05 may report that the UE itself has flight path information to a gNB e-10 through an RRCSetupComplete/RRCResumeComplete/RRCReestablishmentComplete/RRCReconfiguratio nComplete message. In order to report the existence of the flight path information, an indicator such as flightPathInfoAvailable may be included in the messages. For example, the indicator may be 1 bit.

In operation e-20, the UE e-05 may report its own capability information to the gNB e-10. At this time, through the capability information, it may be indicated whether the UE e-05 supports the flight path information report and whether the UE supports flight path information update.

In operation e-25, the gNB e-10 may make a request for reporting the flight path to the UE e-05 through a UEInformationRequest message. At this time, the maximum number of waypoints (or the number of waypoints to be reported) which can be reported by the UE e-05 through a UEInformationResponse message e-30 and whether to insert time information into waypoint information may also be indicated.

In operation e-30, the UE e-05 may report flight path information to the gNB e-10 through the UEInformationResponse message. The UE e-05 may report the maximum number of waypoints configured by the gNB e-10 through the UEInformationRequest message e-25 or information on N waypoints within a range of the maximum number of waypoints defined in the standard to the gNB e-10 (or when the gNB configures the number of waypoints to be reported, the UE may report information on the waypoints corresponding to the number to the gNB). Further, only when the gNB e-10 indicates to insert time information into the waypoint information through the UEInformationRequest message d-25, the UE e-05 may insert the time information and, otherwise, may insert the time information without any gNB configuration.

In operation e-35, when the flight path of the UE e-05 is changed, the gNB e-10 may configure the UE to report the updated flight path through an RRC Reconfiguration procedure. At this time, in order to prevent gNB load from increasing due to too frequent flight path update reports of the UE, the gNB e-10 may also configure a prohibit timer value indicating a minimum time interval between the path update reports (for example, when the prohibit timer is configured, the UE may start the prohibit timer when reporting the flight path update and cannot report a new path update before the corresponding prohibit timer expires). Further, the gNB e-10 may configure the UE e-05 whether to newly report all pieces of waypoint information for the changed flight path regardless of the conventionally reported flight path e-30 or partially report only the changed waypoint information based on the conventionally reported flight path e-30.

In operation e-40, the flight path of the UE e-05 may be changed, and the UE e-05 may detect the change in the flight path. When the change in the flight path of the UE e-05 is detected or the UE e-05 has a new flight path in operation e-40, the UE e-05 may start a procedure for reporting whether to update the flight path to the gNB e-10.

When a flight path update condition is met, the UE e-05 may report the updated flight path to the gNB e-10 through a predetermined RRC message in operation e-45. At this time, the UE e-05 may newly report all pieces of waypoint information for the changed flight path or may partially report only the changed waypoint information compared to the conventionally reported flight path d-30 according to a request from the gNB e-10 in operation e-35. For example, when the conventionally reported flight path includes five waypoints (w1, w2, w3, w4, and w5), the flight path may be changed so that two waypoints (w4 and w5) of the five waypoints may be changed to waypoints (w4′ and w5′) and a new waypoint (w6) may be added. In this case, the UE may report information on all waypoints (w1, w2, w3, w4′, w5′, and w6) included in the changed path or may partially report only the changed waypoints (w4′, w5′, and w6). Further, when only some of the location and time information for specific way points are changed, all pieces of the location and time information for the corresponding waypoints may be newly reported or only the changed location or time information may be partially reported.

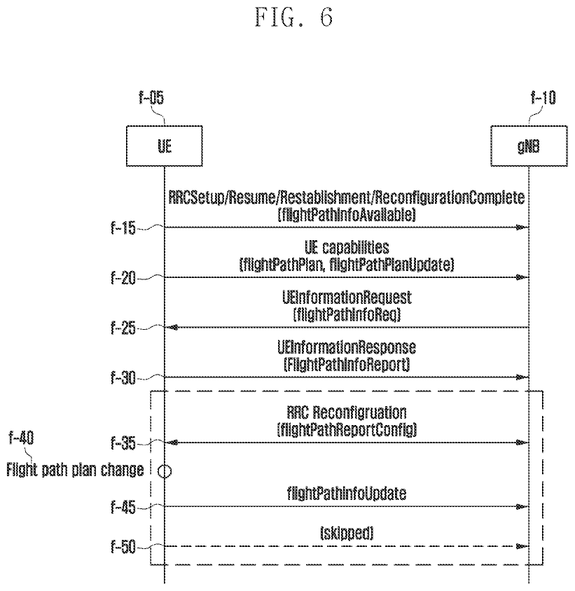

FIG. 6 is a flow diagram illustrating a process of periodically reporting an updated flight path of the aerial UE to the gNB in the next-generation mobile communication system according to an embodiment.

In operation f-15, an aerial UE f-05 may report that the UE itself has flight path information to a gNB f-10 through an RRCSetupComplete/RRCResumeComplete/RRCReestablishmentComplete/RRCReconfiguratio nComplete message. In order to report the existence of the flight path information, an indicator such as flightPathInfoAvailable may be included in the messages. For example, the indicator may be 1 bit.

In operation f-20, the UE f-05 may report its own capability information to the gNB f-10. At this time, through the capability information, it may be indicated whether the UE f-05 supports the flight path information report and whether the UE supports flight path information update.

In operation f-25, the gNB f-10 may make a request for reporting the flight path to the UE f-05 through a UEInformationRequest message. At this time, the maximum number of waypoints (or the number of waypoints to be reported) which can be reported by the UE f-05 through a UEInformationResponse message f-30 and whether to insert time information into waypoint information may also be indicated.

In operation f-30, the UE f-05 may report flight path information to the gNB f-10 through the UEInformationResponse message. The UE f-05 may report the maximum number of waypoints configured by the gNB f-10 through the UEInformationRequest message f-25 or information on N waypoints within a range of the maximum number of waypoints defined in the standard to the gNB f-10 (or when the gNB configures the number of waypoints to be reported, the UE may report information on the waypoints corresponding to the number to the gNB). Further, only when the gNB f-10 indicates to insert time information into the waypoint information through the UEInformationRequest message f-25, the UE f-05 may insert the time information and, otherwise, may insert the time information without any gNB configuration.

In operation f-35, the gNB f-10 may configure the UE f-05 to periodically report the flight path through the RRC Reconfiguration procedure. To this end, the gNB f-10 may configure a flight path report period (or time interval). Further, the gNB f-10 may configure the UE f-05 whether to newly report all pieces of waypoint information for the changed flight path regardless of the conventionally reported flight path or partially report only the changed waypoint information based on the conventionally reported flight path.

In operation f-40, the flight path of the UE f-05 may be changed, and the UE f-05 may detect the change in the flight path.

When a flight path report time point arrives and a flight path update condition is met according to a flight path report configuration made by the gNB in operation f-35, the UE f-05 may report the updated flight path to the gNB f-10 through a predetermined RRC message in operation f-45. At this time, the UE f-05 may newly report all pieces of waypoint information for the changed flight path or may partially report only the changed waypoint information compared to the conventionally reported flight path f-30 according to a request from the gNB f-10 in operation f-35. For example, when the conventionally reported flight path f-30 includes five waypoints (w1, w2, w3, w4, and w5), the flight path may be changed so that two waypoints (w4 and w5) of the five waypoints may be changed to waypoints (s4′ and w5′) and a new waypoint (w6) may be added. In this case, the UE f-05 may report information on all waypoints (w1, w2, w3, w4′, w5′, and w6) included in the changed path or may partially report only the changed waypoints (w4′, w5′, and w6). Further, when only some of the location and time information for specific way points are changed, all pieces of the location and time information for the corresponding waypoints may be newly reported or only the changed location or time information may be partially reported.

On the other hand, when the flight path report time point arrives according to the flight path report configuration made by the gNB f-10 but the flight path update condition is not met in operation f-35, the UE f-05 may omit the flight path report at the corresponding time point (operation f-50).

According to an embodiment, the following operations can be applied in common to the flight path update operation described with reference to FIGS. 3, 4, 5, and 6.

Flight Path Update Condition

An expected flight path of the UE may be continuously changed by the minute according to a flight condition. Accordingly, if the UE reports a flight path updated whenever a change in the flight path is made to the gNB, unnecessary load may be generated. For example, in viewpoint information, location information may be maintained but time information for a time point at which the corresponding waypoint is passed through may be continuously changed by the minute. When the UE reports the flight path updated whenever the change in the flight path is made to the gNB, the gNB load may significantly increase. On the other hand, when the changed information is not much different from the conventional information, there may be no operation which the gNB can additionally perform to optimize supporting of mobility (measurement and HO reconfiguration) of the corresponding UE.

According to an embodiment, the following operations are provided as conditions for determining whether the UE needs to update the flight path (expressed as the ‘flight path update condition’ in the description of FIGS. 4, 5, and 6).

1. When there is any change in the flight path which the UE conventionally reported, the UE may update the flight path. Specifically, if at least one of the following conditions is met for a predetermined waypoint included in the conventionally reported flight path, the flight path update condition may be met.
(1) A change in LocationInfo (location information)
(2) A change in TimeInfo (time information)

However, a change condition for the time information may not be included. The gNB may indicate whether the change condition for time information may be included in the flight path update condition while configuring the UE to report the updated flight path.

Specifically, in the case of the embodiment of FIG. 4, when it is determined whether the update condition is met, additional conditions below may also be considered according to whether the prohibit timer in operation d-50 is configured.

1) When the prohibit timer is configured, the flight path is changed as described in the first option and thus the last reported flight path is different from the current flight path, and when the prohibit timer is not run, the flight path update condition is met.

2) When the prohibit timer is not configured, the flight path update condition is met if at least one of the following conditions is met:
the case in which the flight path is changed as described in the first option and thus the last reported flight path is different from the current flight path;
the case in which the flight path is changed as described in the first option and thus the last reported flight path is different from the current flight path and the UE does not report whether to update the flight path after the last flight path report;
the case in which the flight path at a time point at which the UE last reports whether to update the flight path is different from the current flight path;
the case in which the flight path is changed after the UE last reports whether to update the flight path.

Specifically, in the case of the embodiment of FIG. 5, when it is determined whether the update condition is met, additional conditions below may also be considered according to whether the prohibit timer in operation e-35 is configured.

1) When the prohibit timer is configured, the flight path update condition is met if at least one of the following conditions is met:
the case in which the flight path is changed as described in the first option and thus the last reported flight path is different from the current flight path and the prohibit timer is not run;
the case in which the UE does not have the flight path information and has not yet reported the flight path after the UE is configured to report the flight path update.

2) When the prohibit timer is not configured, the flight path update condition is met if at least one of the following conditions is met:
the case in which the flight path is changed as described in the first option and thus the last reported flight path is different from the current flight path;
the case in which the UE does not have the flight path information and has not yet reported the flight path after the UE is configured to report the flight path update.

2. Second option: when the flight path previously reported by the UE is changed by a specific level or more, the UE may update the flight path. Specifically, if at least one of the following conditions is met for a predetermined waypoint included in the conventionally reported flight path, the flight path update condition may be met.

(1) LocationInfodifference>LocationChangeThreshold
LocationInfodifference: indicates a change between conventionally reported location information and changed location information;
LocationChangeThreshold: indicates a threshold value configured by the gNB. For example, it may be a centimeter or meter unit value.

(2) TimeInfodifference>TimeChangeThreshold
TimeInfodifference: indicates a change between conventionally reported time information and changed time information;
TimeChangeThreshold: indicates a threshold value configured by the gNB. For example, it may be a msec, sec, min, hour unit value.

However, a change condition for the time information may not be included. The gNB may also indicate whether the change condition for the time information may be included in the flight path update condition while configuring the UE to report the updated flight path.

Specifically, in the case of the embodiment of FIG. 4, when it is determined whether the update condition is met, the following additional conditions may also be considered according to whether the prohibit timer in operation d-50 is configured:

1) When the prohibit timer is configured, the path flight is changed as described in the second option and the last reported flight path is different from the current flight path by a specific level or more, and when the prohibit timer is not run, the flight path update condition is met.

2) When the prohibit timer is not configured, the flight path update condition is met if at least one of the following conditions is met:
the case in which the flight path is changed as described in the second option and thus the last reported flight path is different from the current path by a specific level or more;
the case in which the flight path is changed as described in the second option and thus the last reported flight path is different from the current flight path by a specific level or more and the UE does not report whether to update the flight path after the last flight path report;
the case in which the flight path at a time point at which the UE last reports whether to update the flight path is different from the current flight path by a specific level or more;
the case in which the flight path after the last report on whether to update the flight path is changed by a specific level or more;

Specifically, in the case of the embodiment of FIG. 5, when it is determined whether the update condition is met, the following additional conditions may also be considered according to whether the prohibit timer in operation e-35 is configured.

1) When the prohibit timer is configured, the flight path update condition is met if at least one of the following conditions is met:
the case in which the flight path is changed as described in the second option and thus the last reported flight path is different from the current flight path by a specific level or more and the prohibit timer is not run;
the case in which the UE has flight path information and has not yet reported the flight path after the UE is configured to report the flight path update.

2) When the prohibit timer is not configured, the flight path update condition is met if at least one of the following conditions is met:
the case in which the flight path is changed as described in the second option and thus the last reported flight path is different from the current flight path by a specific level or more;
the case in which the UE has flight path information and has not yet reported the flight path after the UE is configured to report the flight path update.

3. When a specific number or more of waypoints are changed among the waypoints included in the flight path which the UE previously reported, the UE may update the flight path. Specifically, when the following conditions are met for the waypoints included in the conventionally reported flight path, the flight path update condition is met.

(1) # of changed waypoints>WaypointChangeThreshold
# of changed waypoints: indicates the number of waypoints having a change among the waypoints included in the conventionally reported flight path. As a condition for determining whether there is a change in each waypoint, both the first option and the second option may be used.
WaypointChangeThreshold: indicates a threshold value configured by the gNB.

Specifically, in the case of the embodiment of FIG. 4, when it is determined whether the update condition is met, additional conditions below may also be considered according to whether the prohibit timer in operation d-50 is configured:

1) When the prohibit timer is configured, the flight path is changed as described in the third option and thus waypoints included in the last reported flight path and the current flight path are different by a specific number or more and, when the prohibit timer is not run, the flight path update condition is met.

2) When the prohibit timer is not configured, the flight path update condition is met if at least one of the following conditions is met:
the case in which the flight path is changed as described in the third option and thus waypoints included in the last reported flight path and the current flight path are different by a specific number or more;
the case in which the flight path is changed as described in the third option and thus waypoints included in the last reported flight path and the current flight path are different by a specific number or more and the UE does not report whether to update the flight path after the last flight path report;
the case in which waypoints included in the flight path at a time point at which the last report on whether to update the flight path is performed and the current flight path are different by a specific number or more;
the case in which waypoints included in the flight path after the last report on whether to update the flight path are changed by a specific number or more.

Specifically, in the case of the embodiment of FIG. 5, when it is determined whether the update condition is met, the following additional conditions may also be considered according to whether the prohibit timer in operation e-35 is configured.

1) When the prohibit timer is configured, the flight path update condition is met if at least one of the following conditions is met:
the case in which the flight path is changed as described in the third option and thus waypoints included in the last reported flight path and the current flight path are different by a specific number or more and the prohibit timer is not run;
the case in which the UE has flight path information and has not yet reported the flight path after the UE is configured to report the flight path update;

2) When the prohibit timer is not configured, the flight path update condition is met if at least one of the following conditions is met:
the case in which the flight path is changed as described in the third option and thus the last reported flight path is different from the current flight path by a specific level or more;
the case in which the UE has flight path information and has not yet reported the flight path after the UE is configured to report the flight path update;

4. The UE may update the flight path when a waypoint to move next is different from a waypoint on the conventionally reported flight path. For example, the conventionally reported flight path includes waypoints (w1, w2, w3, and w4) and a new flight path may include waypoints (w1, s2, w3′, and w4′) since the waypoints (w3 and w4) are changed. In this case, the waypoint w3 is changed to the waypoint w3′ after the UE passes through the waypoint w2, and thus the path change update condition may be met and the UE may report the changed flight path. At this time, as the condition for determining whether there is a change in each waypoint, both the first option and the second option may be used.

When one or more of the options are supported in the standard, the gNB may explicitly indicate which option is to be used through an RRC Reconfiguration procedure. Alternatively, the gNB may indirectly indicate the option to be used by configuring parameters required for using a specific option (for example, the case of the third operation or WaypointChangeThreshold) instead of explicitly indicating the option.

The flight path is exchanged between gNBs and the flight path report message of the UE is retransmitted when the UE performs handover

After the UE reports the updated flight path to the serving cell through a predetermined RRC message (for example, UEAssistanceInformation) in FIGS. 4, 5, and 6, the UE may perform handover to another cell. When gNBs operating the serving cell and a target cell are different, the gNB of the serving cell may transfer flight path information of the UE to the gNB of the target cell through signaling between gNBs for preparing the handover. However, when a time point at which the UE updates the flight path is right before the handover is performed (for example, within 1 second), the gNB of the serving cell cannot transfer the updated flight path information of the UE through signaling between gNBs exchanged during a handover preparation process. Accordingly, when the UE reports the flight path updated right before the handover (for example, within 1 second) to the existing cell, a predetermined RRC message including the flight path information may be retransmitted after the handover.

Dual connectivity scenario

When master cell group (MCG) failure is generated in a dual connectivity condition, the UE may transmit a predetermined RRC message including the updated flight path to a secondary cell group (SCG) through one of split signaling radio bearer 1 (SRB1), split SRB2, and SRB3.

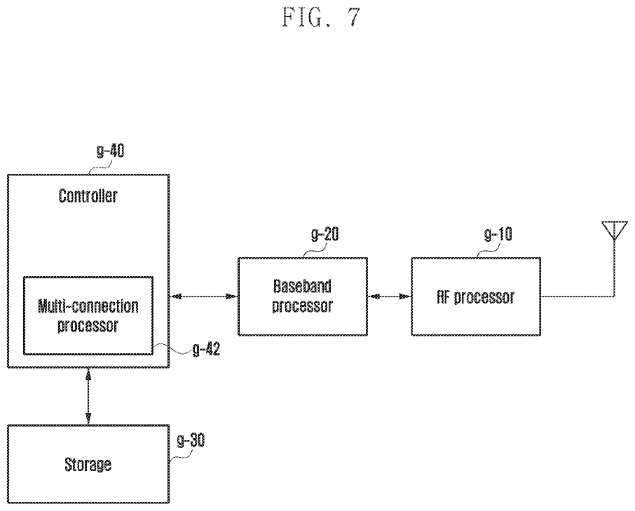

FIG. 7 is a block diagram illustrating an internal structure of the UE according to an embodiment.

Referring to FIG. 7, the UE includes a radio-frequency (RF) processor g-10, a baseband processor g-20, a storage g-30, and a controller g-40.

The RF processor g-10 performs a function of transmitting and receiving a signal through a radio channel such as converting or amplifying a band of the signal. For example, the RF processor g-10 up-converts a baseband signal provided from the baseband processor g-20 into an RF band signal, transmits the RF band signal through an antenna, and down-converts the RF band signal received through the antenna into the baseband signal. The RF processor g-10 may include a transmission filter, a reception filter, an amplifier, a mixer, an oscillator, a digital-to-analog converter (DAC), an analog-to-digital converter (ADC), and the like. Although FIG. 7 illustrates only one antenna, the UE may include a plurality of antennas. Further, the RF processor g-10 may include a plurality of RF chains. Moreover, the RF processor g-10 may perform beamforming. For beamforming, the RF processor g-10 may control a phase and a size of each of the signals transmitted/received through a plurality of antennas or antenna elements. Further, the RF processor g-10 may perform MIMO and may receive several layers when performing the MIMO operation.

The baseband processor g-20 performs a function for a conversion between a baseband signal and a bitstream according to a physical layer standard of the system. For example, in data transmission, the baseband processor g-20 generates complex symbols by encoding and modulating a transmission bitstream. Further, in data reception, the baseband processor g-20 reconstructs a reception bitstream by demodulating and decoding a baseband signal provided from the RF processor g-10. For example, in an orthogonal frequency division multiplexing (OFDM) scheme, when data is transmitted, the baseband processor g-20 generates complex symbols by encoding and modulating a transmission bitstream, maps the complex symbols to subcarriers, and then configures OFDM symbols through an inverse fast Fourier transform (IFFT) operation and a cyclic prefix (CP) insertion. Further, when data is received, the baseband processor g-20 divides the baseband signal provided from the RF processor g-10 in the unit of OFDM symbols, reconstructs the signals mapped to the subcarriers through a fast Fourier transform (FFT) operation, and then reconstructs a reception bitstream through demodulation and decoding.

The baseband processor g-20 and the RF processor g-10 may transmit and receive the signal as described above. Accordingly, each of the baseband processor g-20 and the RF processor g-10 may be referred to as a transmitter, a receiver, a transceiver, or a communication unit. Further, at least one of the baseband processor g-20 and the RF processor g-10 may include a plurality of communication modules to support a plurality of different radio access technologies. In addition, at least one of the baseband processor g-20 and the RF processor g-10 may include different communication modules to process signals in different frequency bands. For example, the different radio access technologies may include a wireless LAN (for example, IEEE 802.11) and a cellular network (for example, LTE). Further, the different frequency bands may include a super high frequency (SHF) (for example, 2. NRHz, NRhz) band and a millimeter wave (mm wave) (for example, 60 GHz) band.

The storage g-30 stores data such as a basic program, an application program, configuration information, and the like for the operation of the UE. Particularly, the storage g-10 may store information related to a second access node performing wireless communication using a second radio access technology. Further, the storage g-30 provides the stored data according to a request from the controller g-40.

The controller g-40 controls the overall operation of the UE. For example, the controller g-40 transmits and receives a signal through the baseband processor g-20 and the RF processor g-10. Further, the controller g-40 records data in the storage g-30 and reads the data. To this end, the controller g-40 may include at least one processor g-42. For example, the controller g-40 may include a communications processor (CP) that performs control for communication, and an application processor (AP) that controls higher layers such as an application program.

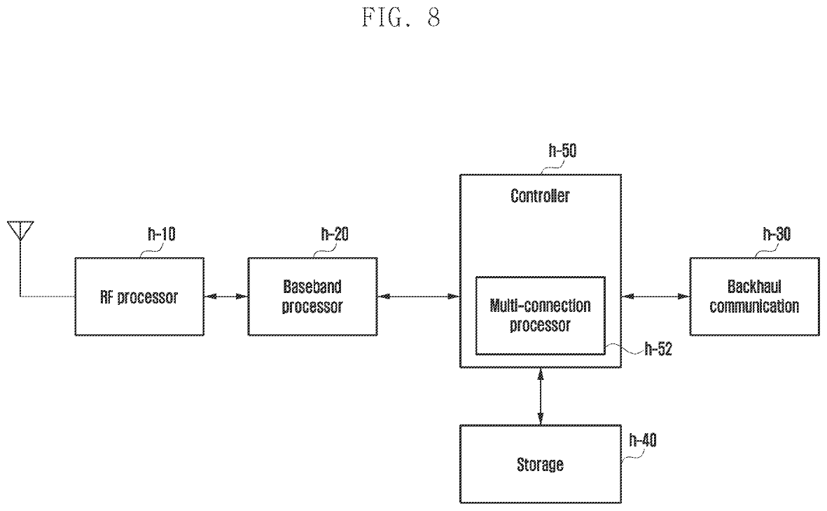

FIG. 8 is a block diagram illustrating a configuration of the gNB according to an embodiment.

As illustrated in FIG. 8, the gNB includes an RF processor h-10, a baseband processor h-20, a backhaul communication unit h-30, a storage h-40, and a controller h-50.

The RF processor h-10 performs a function of transmitting and receiving a signal through a radio channel such as converting or amplifying a band of the signal. For example, the RF processor h-10 up-converts a baseband signal provided from the baseband processor h-20 into an RF band signal, transmits the RF band signal through an antenna, and down-converts the RF band signal received through the antenna into the baseband signal. The RF processor h-10 may include a transmission filter, a reception filter, an amplifier, a mixer, an oscillator, a DAC, an ADC, and the like. Although FIG. 8 illustrates only one antenna, the first access node may include a plurality of antennas. Further, the RF processor h-10 may include a plurality of RF chains. In addition, the RF processor h-10 may perform beamforming. For beamforming, the RF processor h-10 may control a phase and a size of each of the signals transmitted/received through a plurality of antennas or antenna elements. The RF processor may perform a downlink MIMO operation by transmitting one or more layers.

The baseband processor h-20 performs a function of performing conversion between a baseband signal and a bitstream according to a physical-layer standard of the first radio access technology. For example, in data transmission, the baseband processor h-20 generates complex symbols by encoding and modulating a transmission bitstream. Further, in data reception, the baseband processor h-20 reconstructs a reception bitstream by demodulating and decoding a baseband signal provided from the RF processor h-10. For example, in an OFDM scheme, when data is transmitted, the baseband processor h-20 may generate complex symbols by encoding and modulating the transmission bitstream, map the complex symbols to subcarriers, and then configure OFDM symbols through an IFFT operation and CP insertion. In addition, when data is received, the baseband processor h-20 divides a baseband signal provided from the RF processor h-10 in units of OFDM symbols, recovers signals mapped with sub-carriers through an FFT operation, and then recovers a reception bit string through demodulation and decoding. The baseband processor h-20 and the RF processor h-10 may transmit and receive signals as described above. Accordingly, each of the baseband processor h-20 and the RF processor h-10 may be referred to as a transmitter, a receiver, a transceiver, or a communication unit.

The backhaul communication unit h-30 provides an interface for communicating with other nodes within the network. That is, the backhaul communication unit h-30 converts a bitstream transmitted from a master evolved NodeB (MeNB) to another node, for example, a secondary evolved NodeB (SeNB), a core network, or the like into a physical signal and converts the physical signal received from the other node into the bitstream.

The storage h-40 stores data such as a basic program, an application program, configuration information, and the like for the operation of the gNB. Particularly, the storage h-40 may store information on bearers allocated to the accessed UE and the measurement result reported from the accessed UE. Further, the storage h-40 may store information which is the reference for determining whether to provide multiple connections to the UE or stop the multiple connections. In addition, the storage h-40 provides the stored data according to a request from the controller h-50.

The controller h-50 controls the overall operation of the MeNB. For example, the controller h-50 transmits and receives a signal through the baseband processor h-20 and the RF processor h-10 or through the backhaul communication unit h-30. Further, the controller h-50 records data in the storage h-40 and reads the data. To this end, the controller h-50 may include at least one processor h-52.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Furthermore, a plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments, but should be defined by the appended claims and equivalents thereof

What is claimed is:

1. A terminal in a wireless communication system, the terminal comprising:
a transceiver; and
at least one processor is configured to:
receive, from a base station via the transceiver, a first message for configuring a flight path update notification,
identify that a flight path is updated, and
transmit, to the base station via the transceiver, a second message including a flight path update indication for indicating that the flight path is updated based on the first message and the identification.

2. The terminal of claim 1, wherein the first message includes information on a threshold for triggering the flight path update notification,
wherein the second message is transmitted based on the information on the threshold for triggering the flight path update notification,
wherein the information on the threshold associated either a time or a distance, and
wherein the flight path update indication is included in user equipment (UE) assistance information.

3. The terminal of claim 1, wherein the at least one processor is further configured to:
receive, from the base station via the transceiver, a third message for requesting a flight path report, and
transmit, to the base station via the transceiver, a fourth message for reporting information on the updated flight path.

4. The terminal of claim 3, wherein the third message includes information for configuring to report either all or part of the updated flight path.

5. The terminal of claim 1, wherein the at least one processor is further configured to:
transmit, to the base station via the transceiver, a fifth message for indicating whether flight plan information is available,
receive, from the base station via the transceiver, a sixth message for requesting a flight path report, and
transmit, to the base station via the transceiver, a seventh message for reporting information on the flight plan information.

6. A base station in a wireless communication system, the base station comprising:
a transceiver; and
at least one processor is configured to:
transmit, to a terminal via the transceiver, a first message for configuring a flight path update notification, and
receive, from the terminal via the transceiver, a second message including a flight path update indication for indicating that a flight path is updated in case that the flight path being updated is identified.

7. The base station of claim 6, wherein the first message includes information on a threshold for triggering the flight path update notification,
wherein the second message is transmitted based on the information on the threshold for triggering the flight path update notification,
wherein the information on the threshold associated either a time or a distance, and
wherein the flight path update indication is included in user equipment (UE) assistance information.

8. The base station of claim 6, wherein the at least one processor is further configured to:
transmit, to the terminal via the transceiver, a third message for requesting a flight path report, and
receive, from the terminal via the transceiver, a fourth message for reporting information on the updated flight path.

9. The base station of claim 8, wherein the third message includes information for configuring to report either all or part of the updated flight path.

10. The base station of claim 6, wherein the at least one processor is further configured to:
receive, from the terminal via the transceiver, a fifth message for indicating whether flight plan information is available,
transmit, to the terminal via the transceiver, a sixth message for requesting a flight path report, and
receive, from the terminal via the transceiver, a seventh message for reporting information on the flight plan information.

11. A method performed by a terminal in a wireless communication system, the method comprising:
receiving, from a base station, a first message for configuring a flight path update notification;
identifying that a flight path is updated; and
transmitting, to the base station, a second message including a flight path update indication for indicating that the flight path is updated based on the first message and the identification.

12. The method of claim 11, wherein the first message includes information on a threshold for triggering the flight path update notification,
wherein the second message is transmitted based on the information on the threshold for triggering the flight path update notification,
wherein the information on the threshold associated either a time or a distance, and
wherein the flight path update indication is included in user equipment (UE) assistance information.

13. The method of claim 11, further comprising:
receiving, from the base station, a third message for requesting a flight path report; and
transmitting, to the base station, a fourth message for reporting information on the updated flight path,
wherein the third message includes information for configuring to report either all or part of the updated flight path.

14. A method performed by a base station in a wireless communication system, the method comprising:
transmitting, to a terminal, a first message for configuring a flight path update notification; and
receiving, from the terminal, a second message including a flight path update indication for indicating that a flight path is updated in case that the flight path being updated is identified.

15. The method of claim 14, further comprising:
transmitting, to the terminal, a third message for requesting a flight path report; and
receiving, from the terminal, a fourth message for reporting information on the updated flight path,
wherein the first message includes information on a threshold for triggering the flight path update notification,
wherein the second message is transmitted based on the information on the threshold for triggering the flight path update notification,
wherein the information on the threshold associated either a time or a distance,
wherein the flight path update indication is included in user equipment (UE) assistance information, and
wherein the third message includes information for configuring to report either all or part of the updated flight path.
